(19) United States
(12) Patent Application Publication
(10) Pub. No.: US 2018/0211346 A1
(43) Pub. Date: Jul. 26, 2018

(54) PICKUP LOCATION OPERATIONS PERFORMED BASED ON USER FEEDBACK

(71) Applicant: Amazon Technologies. Inc., Reno, NV (US)

(72) Inventors: Nicholas John Morren, Seattle, WA (US); Rucheek Hasmukh Sangani, Kirkland, WA (US); Neha Goswami, Seattle, WA (US); Denis Trong Nguyen, Seattle, WA (US); Richard Scott McNew, Mukilteo, WA (US)

(21) Appl. No.: 14/014,176

(22) Filed: Aug. 29, 2013

(51) Int. Cl. G06Q 50/28; G06Q 30/02

(52) U.S. Cl. CPC G06Q 50/28; G06Q 30/0207

(57) ABSTRACT

Pickup location operations may be performed based on trusted user feedback. For example, a user may provide feedback that an ordered item at a pickup location is missing or damaged, in response to which a refund or replacement may be issued. Feedback may also be provided to indicate that a malfunction is occurring at the pickup location, in response to which the malfunctioning equipment may be disabled and a repair request may be made. Feedback may also be provided to indicate that a scheduled time period for a user to retrieve an item from the pickup location needs to be changed, in response to which an alternative time period may be selected.

### BACKGROUND

Many companies package items and/or groups of items together for a variety of purposes, such as e-commerce and mail-order companies that package items (e.g., books, CDs, apparel, food, etc.) to be shipped to fulfill orders from customers. Retailers, wholesalers, and other product distributors (which may collectively be referred to as distributors) typically maintain an inventory of various items that may be ordered by customers. This inventory may be maintained and processed at a materials handling facility which may include, but is not limited to, one or more of: warehouses, distribution centers, cross-docking facilities, order fulfillment facilities, packaging facilities, shipping facilities, or other facilities or combinations of facilities for performing one or more functions of material (inventory) handling.

In some instances, a customer may order an item and designate a pickup location as the delivery location. A pickup location may include a control station and storage compartments where the items that are ordered from a materials handling facility can be delivered for pickup by customers. Rather than shipping the item to a residence or place of business, the item may be shipped to the pickup location and stored in a storage compartment for retrieval by the customer. The pickup location may include various types of sensors for detecting certain types of issues that may occur at the pickup location. For example, a presence detection sensor in a storage compartment may be utilized to detect when a customer has accidentally left an item in the storage compartment. However, certain other types of issues may be more difficult to detect, such as damage to an item during shipping or a malfunctioning storage compartment.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a broad view of the operation of a materials handling facility, in one implementation.

FIG. 2 depicts a block diagram of a pickup location, in one implementation.

FIG. 3 depicts a block diagram of an illustrative distributed pickup location environment, in one implementation.

FIG. 4 is a flow diagram illustrating an example process for performing pickup location operations based on feedback from a user.

FIG. 5 is a flow diagram illustrating an example process for adjusting the timing for the retrieval of an item by a user.

FIG. 6 is a flow diagram illustrating an example process for addressing an issue with an item.

FIG. 7 is a flow diagram illustrating an example process for addressing a pickup location malfunction.

FIG. 8 is a block diagram illustrating an example computer system configured to implement one or more of the systems or processes described herein.

While implementations are described herein by way of example, those skilled in the art will recognize that the implementations are not limited to the examples or drawings described. It should be understood that the drawings and detailed description thereto are not intended to limit implementations to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

This disclosure describes systems and methods for performing actions related to pickup location activities based on feedback from a user. In various implementations, a user may be a customer, carrier, agent, or any other entity which utilizes or interacts with the pickup location. Various types of issues may be indicated by the feedback from a user. For example, a user may indicate that an ordered item is damaged or missing, that a malfunction is occurring with a storage compartment or control station of the pickup location, that the user will not be able to retrieve an item from the pickup location within an allotted time window, etc. For certain issues, such as malfunctions occurring at the pickup location or a damaged or missing item, a confidence threshold may be determined which represents a confidence in the occurrence of the issue indicated by the user. The determination of whether the confidence threshold is satisfied may be based in part on an evaluation of past purchases, returns or reports of issues by the user. If the confidence threshold is satisfied, then action may be taken to address the issue. For example, if the issue is a malfunction occurring at the pickup location, the action taken may include sending a request for repair or disabling the malfunctioning equipment. If the confidence threshold is not satisfied, then additional confirmation of the issue may be required. For example, additional confirmation of a malfunction may include additional reports of the malfunction from other users of the pickup location, or through various diagnostic processes that may be performed. In various implementations, the confidence threshold may be different for different users, pickup locations, issues, items, etc. For example, a high volume pickup location may have a higher confidence threshold to be met for disabling equipment than a low volume pickup location.

As an example of an issue with an item, the user may have arrived at a pickup location to retrieve an item that was ordered for the user, and may have discovered that the item is missing or damaged. Alternatively, the user may wish to return the item for other reasons, such as having ordered multiple versions of an item in order to select a preferred size or color. To address the issue, if a confidence threshold is satisfied, an automatic refund or replacement process for the item may be initiated.

As an example of a malfunction occurring at a pickup location, the malfunction may be related to a storage compartment at a pickup location, such as a door that will not open for the retrieval of an item, or that will not stay closed or locked for the return of an item. A malfunction may also be related to a control station, such as not receiving or processing input from a user correctly, or not being able to provide certain services. In response to the report of the malfunction from the user, if a confidence threshold is satisfied, the malfunctioning equipment may be disabled and/or a request for a repair may be made.

In some implementations, a user may also modify the time during which they can retrieve an item from a pickup location. For example, a user may receive a notification that the ordered item has, or is expected to, arrive at the pickup location by a certain date, and that the user will have a limited time window, such as three days, in which to retrieve the item before it will be returned to a fulfillment center. In some instances, the item may be arriving at the pickup location before a specified promise date that was indicated when the item was first ordered, and thus may be earlier than the user had been expecting. In such a circumstance, or for other reasons, the user may not be able to retrieve the item during the first time period and may request a change to a second time period. The second time period may include an extension or shifting of the time window indicated by the first time period. To determine what time periods are available, the storage capacity and current scheduled activities for the pickup location may be evaluated. Assuming the pickup location has capacity to accommodate the alternative time period, an adjustment process may be performed to make the item available for retrieval by the user during the second time period. As part of the adjustment process, another item may be allowed to take the place of the item in the storage compartment until the second time period begins, so as to more fully utilize the available storage capacity of the pickup location.

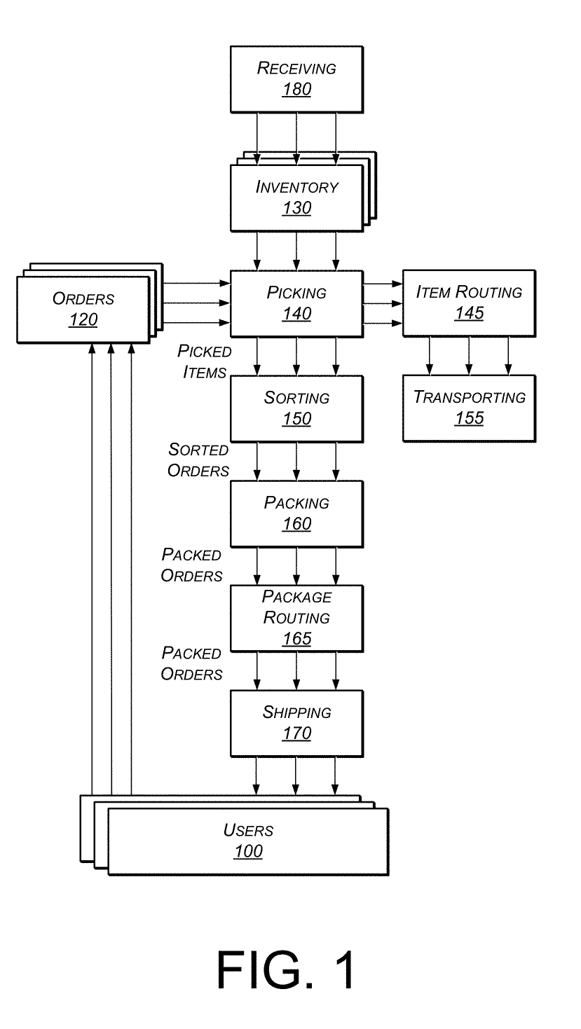

A block diagram of a materials handling facility, which, in one implementation, may be an order fulfillment facility configured to utilize various systems and methods described herein, is illustrated in FIG. 1. In this example, multiple users 100 may submit orders 120, where each order 120 specifies one or more items from inventory 130 to be shipped to the user or to another entity specified in the order. An order fulfillment facility typically includes a receiving operation 180 for receiving shipments of stock from various vendors and storing the received stock in inventory 130. To fulfill the orders 120, the item(s) specified in each order may be retrieved or “picked” from inventory 130 (which may also be referred to as stock storage) in the order fulfillment facility, as indicated by picking operation 140. In some implementations, the items of a user order may be divided into multiple shipment sets for fulfillment by a planning service before fulfillment instructions are generated (not shown). As used herein, the term “shipment set” may refer to a single item of a user's order, multiple items of a user's order, or all items of a user's order.

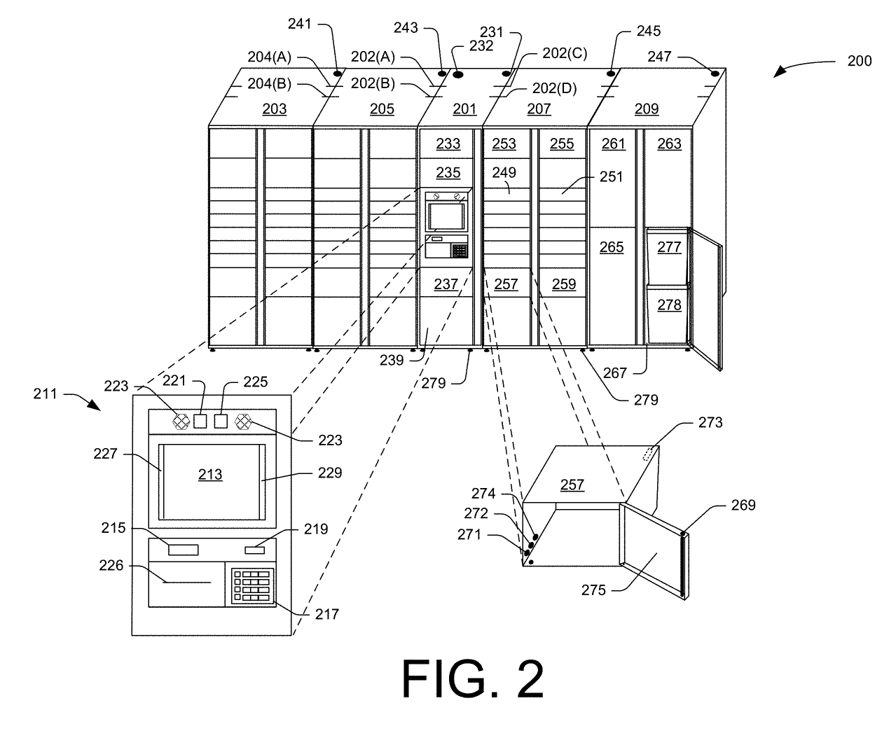

In some instances, when a user has selected a pickup location, such as the pickup location described below with respect to FIG. 2, as the delivery destination, the item(s) of one or more shipment sets may be picked at the picking operation 140 directly into delivery containers. A “delivery container,” as used herein, may be any form of container used in transporting or handling items. For example, a delivery container may be a tote, pallet, bin, trailer, etc. Additionally, the delivery container may be segmented or otherwise include division points, permanent or movable, that enable separation of items within the delivery container. In some instances, items themselves, such as larger items (e.g., big screen televisions, desks, cabinets) may be considered and treated as delivery containers. The delivery container may also include a unique identifier, such as a bar code, QR code, unique number, etc. to enable tracking and identification of the delivery container and association of items placed in the delivery container. For example, during a picking operation, an agent within the materials handling facility may scan the bar code of the delivery container and scan a barcode or identifier of the picked item as the item is placed into the delivery container. Scanning of the delivery container and the picked item results in the item becoming associated with and tracked with the delivery container. In some implementations, for delivery containers that are segmented or otherwise include division points, those segments may each include a unique identifier (e.g., bar code) and as items are placed in the delivery container they may be associated with a specific location, or segment within the delivery container by scanning the identifier of that segment. Likewise, because items may not be packed in shipping packages, the packing slip typically included in a shipping package may be applied to the item (e.g., stickered to the item), printed out at the pickup location upon retrieval of the item, or otherwise made available to a user.

Regardless of the type of delivery container utilized, in some implementations, items for which a pickup location has been selected as the final delivery destination do not need to be packed in a shipping package and can be transported to the pickup location in the delivery container. In other instances, items that are pre-packaged or fragile items that need additional protection prior to transport may be picked and transported to a pickup location in a delivery container. In another implementation, items may be put in bags prior to placement in the delivery container and/or storage compartment to provide confidentiality of the ordered items. In addition, items from multiple shipment sets destined for the same pickup location may be picked into the same delivery container for transport. As delivery containers are filled, an item routing operation 145 may route the filled delivery containers to the appropriate transporting operation 155 for transport to the designated pickup location. The item routing operation 145 may be manual or automated. The item routing operation 145 may receive an indication of the pickup location in which each item should be routed from a shipment planning system and route delivery containers to one of two or more transporting operations 170, from which they may be transported to the pickup location.

In other examples, for items not scheduled for delivery to a pickup location, picked items may be delivered to one or more stations in the order fulfillment facility for sorting 150 into their respective shipment sets and for packing 160 in shipping packages. A package routing operation 165 may sort orders for packing in shipping packages to one of two or more shipping operations 170, from which they may be shipped to the users 100. The package routing operation 165 may in various implementations be automated or manual. The package routing operation 165 may receive an indication of the destination to which each packed shipment set should be routed from a central control system. In some instances, the destination may be the final destination identified by the user or a pickup location at which transfer of a shipment set may occur for final delivery to the user. The package routing operation 165 may also determine a routing destination for each packed shipment set dependent on the size of a shipping package in which the shipment set is contained and/or based on whether the shipment set will be delivered directly to the user or be delivered to a pickup location at which transfer of the shipment set will occur for final delivery to the user.

The arrangement and order of operations illustrated by FIG. 1 is merely one example of many possible implementations of the operation of a materials handling facility, such as an order fulfillment facility, that enables transport of items directly to pickup locations without packing the items. Other types of materials handling, manufacturing, or order fulfillment facilities may include different, fewer, or additional operations and resources, according to different implementations.

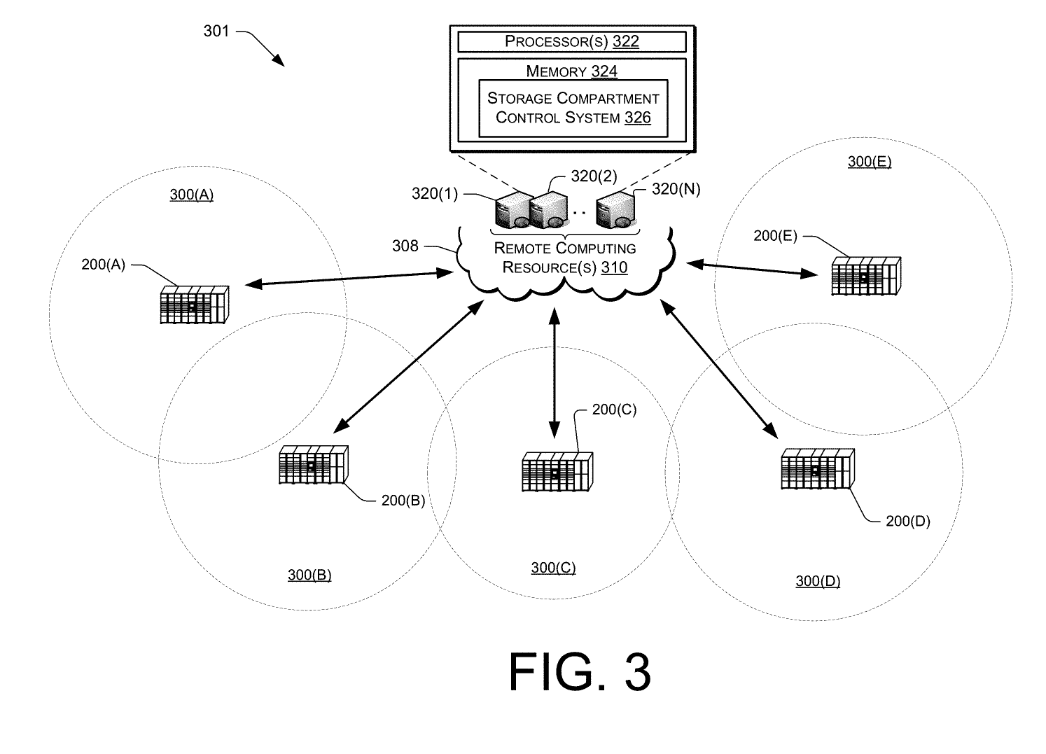

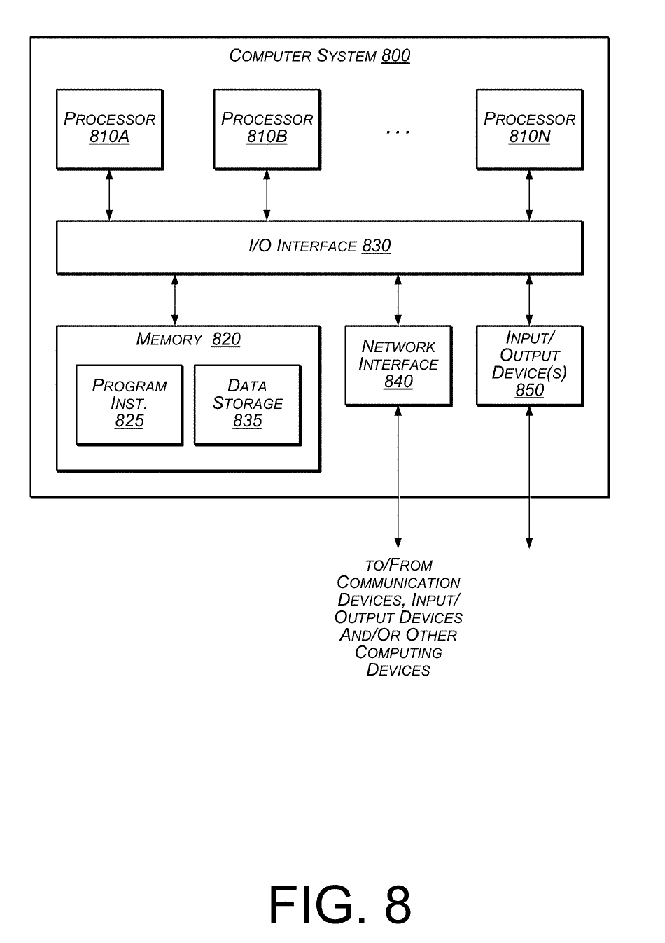

FIG. 2 depicts a block diagram of a pickup location 200, in one implementation. The pickup location 200 may include one or more control stations 201 and one or more storage compartment modules 203, 205, 207, 209. The control station 201 acts as the central control point for the pickup location 200, providing power, computing resources, user input and network access to the pickup location 200. For example, control station 201 may include an internal computing system (not shown), such as a computing system described below with respect to FIG. 8, or other computing system, that is capable of maintaining state information for each storage compartment at the pickup location 200 and providing other computing functions. For example, the internal computing system may include a command component that maintains information as to which storage compartments of the pickup location 200 are empty, which storage compartments include items, the access code(s) or other identifier(s) necessary to open each of the storage compartments and any other information necessary to maintain the pickup location. The command component may also issue commands or instructions to the storage compartment modules to lock/unlock storage compartments, active sensors, and the like. The pickup location 200 may be configured to obtain information from a remote computing resource, shipment planning system, capacity planning system or material handling facility or may be configured to operate primarily as a stand-alone unit, with limited external communication to provide capacity information and/or to receive/provide order/delivery/transfer information. FIG. 3, described below, illustrates an example of an environment in which a centralized control system is provided for remotely communicating with a group of geographically distributed pickup locations 200.

The control station 201 may also include a user interface 211. The user interface 211 is configured to receive and provide information to one or more users of the pickup location 200 and may include, but is not limited to, a display 213, such as a touch-screen display, a scanner 215, a keypad 217, a biometric scanner 219, an audio transducer 221, one or more speakers 223, one or more image capture devices 225, such as a video camera, and any other types of input or output devices that may support interaction between the pickup location 200 and one or more users. For example, the user interface 211 may also include a credit card reader, the ability to accept money (such as cash or coins) and/or the ability to vend items (e.g., stamps, labels, envelopes, shipping packages) using a vending slot 226. Providing the ability for the pickup location 200 to accept credit cards and/or money enables the delivery of orders to a storage compartment at the pickup location 200 for which the items are paid for at the time of pickup (e.g. cash on delivery). Likewise enabling vending of items, such as stamps or envelopes, supports the ability for users to utilize a pickup location to ship or deliver goods, as described in more detail below.

In addition to including user input and output devices, the user interface 211 may also include the ability to collect particulates, such as for use in detection of hazardous (e.g., explosives) or banned substances (e.g. drugs). In one implementation, the user interface 211 may include a particulate sensor that includes a forced air ejection component 227 and an air intake component 229. The air ejection component expels air from a left side of the display 213 while a user is interacting with or otherwise within a predetermined range of the display 213. Opposite the air ejection component 227, the air intake component 229 collects the ejected air and any particulates that are collected as the air passes over the display 213 and past the user's hand or fingers as they interact with the display 213. Collected particulates may be scanned or otherwise processed to determine if potentially hazardous or banned substances may be placed in a storage compartment using any known particulate testing technique. If particulates indicating the potential presence of hazardous or banned substances are detected, the control station 201 may determine to not open a storage compartment door, may alert the authorities, or take other protective actions (such as shutting down the pickup location or performing additional tests). For example, if the air intake component 229 collects gasoline vapor particulates within a pickup location, the control station 201 may contact the appropriate authorities (e.g., police, fire, etc.)

The control station 201 may also include a connector component configured to provide wired and/or wireless network connectivity with the other storage compartment modules 203, 205, 207, 209, as well as to remote computing devices (FIG. 3) or materials handling facilities. Wireless connectivity may be implemented using a wireless antenna 231, which may provide both receive and transmit functionality. Power and/or network communication with remote computing devices may be obtained from a main access point 232. In addition, in some implementations, the control station 201 may include one or more storage compartments 233, 235, 237, 239. As described in more detail below with respect to the storage compartment modules 203, 205, 207, 209, the storage compartments 233, 235, 237, 239 of the control station 201 may be of any size or configuration. As with each of the other storage compartments, the storage compartments 233, 235, 237, 239 of the control station 201 may include an automated locking mechanism, image capture device, a motion or presence detection mechanism, temperature sensor, etc. Alternatively, in some implementations one or more of the storage compartments may be utilized as an additional user interface. For example, storage compartment 239 may be removed and the space remaining may be utilized to provide a scale or other type of weight determination component to allow users to weigh items for shipment, determine the cost necessary to ship the item, and pay for shipping using the user interface 211.

The control station 201 may include one or more connector components 202(A), 202(B), 202(C), 202(D) to which a storage compartment module, such as storage compartment module 205 or storage compartment module 207 may connect with the control station 201. For example, connector component 202(A) may provide power to storage compartment module 205, connector component 202(B) may provide communication with storage compartment module 205, connector component 202(C) may provide power to storage compartment module 207 and connector component 202(D) may provide communication with storage compartment module 207. Likewise, the storage compartment modules may also include one or more connector component, such as connector component 204(A), 204(B) to provide power and connectivity to additional storage compartment modules, such as storage compartment module 203.

Each storage compartment module, such as storage compartment modules 203, 205, 207, 209, may be configured so the pickup location 200 is modular, such that one or more storage compartment modules can be easily removed or added to the control station 201 of the pickup location 200. The ability to add or remove storage compartment modules at a pickup location 200 supports the ability to easily and quickly expand or remove capacity so that the demand for that pickup location can be satisfied. For example, during the Christmas holiday season, additional storage compartment modules may need to be added to the pickup location 200 to support the increased demand of items ordered by users. As storage compartment modules 203, 205, 207, 209 are added or removed from a pickup location 200, the control station 201 informs the warehouse management system and/or a capacity planning system of the added or removed capacity.

Each storage compartment module 203, 205, 207, 209 includes one or more storage compartments, one or more receptor components for connecting with connector components of a control station 201 (or another storage compartment module) and one or more connector components for allowing other storage compartment modules to connect thereto, thereby providing power and/or connectivity with the control station 201. The storage compartments of each storage compartment module may be of varying sizes and number. As such, storage compartment modules with different storage compartment sizes can be added to a pickup location 200 to optimize the storage compartment configuration to match that of the sizes of orders typically scheduled for delivery to the pickup location.

In addition to including storage compartments, power and connectivity points, the storage compartment modules 203, 205, 207, 209 may also include one or more wireless antennas 241, 243, 245, 247 and one or more computing systems, such as the computing system described with respect to FIG. 8, or a simpler computing system such as a printed circuit board, RFID tag, or anything else that may be detectable by the control station 201 and used to identify the storage compartment module. The computing component(s) of each storage compartment module may include a unique identifier of the storage compartment module and configuration information of the storage compartment module, which includes dimension information and location information of each storage compartment of the storage compartment module. The computing component may also include a storage compartment management component configured to control the actuators that enable locking and unlocking of the storage compartment doors of the storage compartment module 203, 205, 207, 209 in response to receiving commands or instructions from a command component of the control station 201.

A storage compartment module, such as storage compartment module 207, when added to a control station 201 and power is applied, provides information to the control station 201 identifying the storage compartment module 207, the number, location, and dimensions of each storage compartment of the storage compartment module and any other configuration or information necessary to enable the control station 201 to control the storage compartment module 207. As illustrated by the comparison between storage compartment module 207 and storage compartment module 209, each storage compartment module may have a variety of different configurations, sizes and numbers of storage compartments. For example, storage compartment module 207 includes a group of small storage compartments, such as small storage compartments 249, 251, a group of medium-sized storage compartments, such as medium-sized storage compartments 253, 255 and a group of larger storage compartments, such as larger storage compartments 257, 259. In contrast, storage compartment module 209 includes four very large storage compartments 261, 263, 265, 267. It will be appreciated that any number, size and configuration of storage compartments of a storage compartment module may be utilized with the various implementations described herein.

In an alternative implementation, rather than providing all of the information from the storage compartment module to the control station 201, the storage compartment module 207 may only provide limited information, such an identifier, to the control station 201. The control station 201, upon receiving the limited information from an added storage compartment module 207, may make a request to a remote computing system, such as a capacity planning system, and obtain information about the configuration, number and sizes of the storage compartments of the added storage compartment module 207.

The control station 201, upon receiving identifying information of an added storage compartment module 207, may allocate the added capacity to the pickup location 200, and may inform a remote computing resource such as will be described in more detail below with respect to FIG. 3. In various implementations, the added storage compartment module may act as a slave component for the control station, receiving instructions (e.g., open storage compartment, close storage compartment, activate image capture device, monitor motion sensor) from the command component of the control station 201 and providing responses (e.g., closed-door, closed, open-door, object/movement detected) to the control station 201 via the storage compartment management component.

Each storage compartment of a storage compartment module 203, 205, 207, 209 or control station 201 includes an upper, bottom, side and rear surfaces and at least one door configured to form a cavity in which items may be stored. In addition, each storage compartment may include various security or other components. For example, looking at the expanded view of storage compartment 257, disposed within the cavity the storage compartment may include a locking mechanism 269, which may be controlled remotely by the command component of the control station 201 via the storage compartment management component, a presence detection sensor 271, motion sensor 272, an image capture device 273, a temperature sensor 274, and a mirror (or other reflective surface) on the top inside of the storage compartment unit (not shown). The locking mechanism 269 may be controlled by the control station 201, either through wired or wireless communication with the storage compartment management component, to effect locking and unlocking of the door 275 of the storage compartment 257. For example, when a user interacts with the control station 201 via the display 213 and provides an access code or other identifier, the control station 201 may identify a specific storage compartment associated with the access code or other identifier and the command component may wirelessly send instructions to the storage compartment management component of the storage compartment module 207 to unlock a storage compartment 257. The instructions may include a command (e.g., unlock), an address or identifier of the specific storage compartment and any other information necessary for communication between the control station 201 and the storage compartment module 207. In response to receiving the instructions from the command component, the storage compartment management component of the storage compartment module 207 may activate a locking mechanism that moves the pins of the locking mechanism 269 on the door 275 of the identified storage compartment 257 such that the pins retract, thereby disengaging the lock of the storage compartment 257 allowing the door 275 to open. In some implementations, the storage compartment 257 may also include a spring mechanism (not shown) such that when the locking mechanism 269 of the storage compartment 257 is disengaged, the spring mechanism propels the door 275 outward, thereby identifying to a user that the door 275 is unlocked and the storage compartment 257 is accessible.

While the locking mechanism described above utilizes retractable pins, any mechanical, magnetic, electrical or other form of locking mechanism may be utilized with the various implementations described herein. In addition, the storage compartment 257 may also include magnets to help retrieve and close a door when it is not all the way closed. Also, the locking mechanism of different storage compartments and different storage compartment modules may be the same or different. Moreover, while the above example describes sending instructions from the command component of the control station 201 to the storage compartment management component of the storage compartment module, in other implementations, each storage compartment may be controlled and/or communicated with directly by the control station 201 and/or the command component and/or remote computing resources as will be described in more detail below with respect to FIG. 3.

The presence detection sensor 271 may be used to detect the presence or absence of objects in the storage compartment 257. For example, the presence detection sensor 271 may be utilized when a carrier is placing items, delivery containers and/or transfer containers in the storage compartment 257 to confirm that the item is indeed in the storage compartment 257 before the door 275 is closed and locked by the locking mechanism 269. Additionally, the presence detection sensor 271 and/or motion sensor 272 may also be used when a user is picking up an order stored in the storage compartment 257 or when a carrier is removing items, delivery containers and/or transfer containers from the storage compartment 257. For example, when a user interacts with the control station 201 via the touch control display 213 and provides an access code such that a storage compartment 257 is opened, the presence detection sensor 271 and/or motion sensor 272 may be used to confirm that a user has reached into the storage compartment 257 and removed its contents (or added items in the case of returns or shipping), prior to allowing the storage compartment door 275 to be closed and locked with the locking mechanism 269. In some implementations, there may be multiple presence detection sensors 271 and/or motion sensors 272 distributed throughout the inside of a storage compartment to ensure objects/motion is detected. In still another implementation, the bottom of the storage compartment may include protrusions or rises to position thin items so they are detected by the presence detection sensor 271.

The storage compartments, such as storage compartment 257, may also include an image capture device 273, such as a camera, and optionally an illumination component (not shown), such as a light emitting diode (LED), that may be used to illuminate the inside of the storage compartment 257. The image capture device 273 may also be used to the detect presence or absence of items within the storage compartment 257, detect the item itself, for example to simplify returns, as well as for security. For example, the image capture device 273 may be used to identify the type of object located within the storage compartment 257 and/or to identify or record video/images of access with the storage compartment 257. In addition, the image capture device 273 may be used to determine the amount of space available in the storage compartment 257. For example, an image taken by the image capture device 273 may be transmitted via wired or wireless communication to the control station 201 and the control station 201 may determine the amount of space available in the storage compartment 257. Such information may be used to determine if all items of a shipment set will fit in a single storage compartment 257, if all items associated with a storage compartment are present in the storage compartment, or if the shipment set needs to be divided across multiple storage compartments. In addition, the image capture device 273 may also be used to determine if there is sufficient space in a storage compartment 267 to contain a delivery container 277 and/or transfer container 278.

Some storage compartments, such as storage compartments located vertically higher within a storage compartment module 203, 205, 207, 209 or the control station 201, such as storage compartments 233, 235, 253, 255 may also include a reflective surface, such as a mirror, on the inside top, sides and/or back of the storage compartment to enable a user who cannot see directly into the storage compartment to determine via a reflection off the reflective surface whether they have removed all of the items from the storage compartment. In a similar manner, a reflective surface may be included on the bottom, sides or back of a storage compartment, such as storage compartment 239, located lower within a storage compartment module 203, 205, 207, 209 or the control station 201, so users can determine via a reflection, and without having to bend all the way down to see into the storage compartment, whether all items have been removed.

The image capture device 273 may also be used to determine if all of the items have been removed from the storage compartment 257. For example, a current image taken by the image capture device 273 may be compared to a prior image taken when the storage compartment 257 was empty in order to verify that all of the items have been removed from the storage compartment. In one implementation, the current image taken by the image capture device 273 may be transmitted via wired or wireless communication to the control station 201 and the control station 201 may compare the current image to a stored image of the empty storage compartment 257 using image processing software to determine if all of the items have been removed. For example, when a user closes the door of the storage compartment 257 after removing some items, the control station 201 may use the current image from the image capture device 273 to automatically detect and provide a warning to the user if there are items remaining in the storage compartment 257.

Some storage compartments, such as any of the storage compartments located within a storage compartment module 203, 205, 207, 209 or the control station 201, may be refrigerated storage compartments. In various implementations, such refrigerated storage compartments may include their own cooling mechanisms, or may rely on those of neighboring refrigerated storage compartments to which they are environmentally coupled, or alternatively each of the modules 201, 203, 205, 207, 209 or the entire pickup location 200 may have a centralized cooling system. The temperature of previously non-refrigerated storage compartments may be adjusted to become refrigerated storage compartments, and visa-versa. The temperature in each of the refrigerated storage compartments may be separately adjustable, such that items inside each of the refrigerated storage compartments may be cooled to a desired temperature. For example, items that need to be chilled or frozen at specified temperatures, such as groceries or medical supplies, may be stored in various refrigerated storage compartments.

In various implementations, the temperatures in the refrigerated storage compartments may be adjusted when items are delivered to be placed in the refrigerated storage compartments, or may adjusted in advance. For example, when a refrigerated item is scheduled to be delivered to a pickup location, the temperature of a refrigerated storage compartment may be adjusted to a temperature that is specified for the refrigerated item in advance so that the refrigerated storage compartment will be at the specified temperature when the item is delivered. In one implementation, the image capture device 273 may be used to capture an image of an item when it is delivered and/or placed in a storage compartment in order to try to determine an appropriate storage temperature for the item. For example, an item may have information on a label which identifies a storage temperature, such as “contents to be stored at 32 degrees F. or lower”.

The temperatures in some or all of the refrigerated storage compartments may be controlled by the control station 201. Continuous monitoring and regulating of the temperatures of the refrigerated storage compartments in which such items are kept may be important for verifying the condition of the items. Temperature sensors, such as the temperature sensor 274 of the storage compartment 257, may be utilized for monitoring and regulating the temperature inside each of the refrigerated storage compartments. The refrigerated storage compartments and/or the entire pickup location 200 may be insulated to prevent the dissipation of the cooled air from the refrigerated storage compartments.

In various implementations, one or more of the refrigerated storage compartments may be insulated storage compartments which are cooled by passive cooling elements that are placed within the storage compartments. For example, rather than utilizing an active cooling system which may have components such as compressors and coils, some of the storage compartments may be cooled by passive cooling elements such as cold packs, frozen water bottles, etc. In one implementation, the passive cooling elements may be included in a shipping container with an item when it is shipped to the pickup location. In an alternative implementation, the passive cooling elements may already be at the pickup location and may be added to the insulated storage compartment with the item when it arrives. The number of passive cooling elements to be included with an item may be calculated based on a number of factors. For example, one factor may be an estimated maximum period of time that the item may remain in the storage compartment before it is retrieved by a user. Another factor may be the expected ambient temperature at the pickup location and/or during shipping to the pickup location. Other factors may include the size of the storage compartment, the size and number of items to be included in the storage compartment, etc. Various government regulations may also specify temperatures at which certain items are to be maintained. For example, various federal, state and/or municipal regulations may dictate requirements for storage temperatures for items as well as maximum periods of time that items may be stored at a given temperature. All of these factors may be included in a calculation of how many passive cooling elements should be included in an insulated storage compartment with an item, as well as a determination of a maximum period of time that the item may remain in the storage compartment.

In another example, the pickup location 200 may also include a storage compartment module configured as a drop-box (not shown). Rather than utilizing specific storage compartments of the pickup location 200 to store returned items and/or items for delivery, a storage compartment module configured as a drop-box may be utilized to securely store such items. For example, a drop-box may be configured with a pivoting door or tray that allows items to be placed in the drop-box but not retrieved without having additional access to the drop-box. In some examples, the pivoting door or other form of access may also be locked and access only provided in response to a user interacting with the user interface 211, such as selecting to return an item.

The storage compartment modules 203, 205, 207, 209 as well as the control station 201 may also include self-leveling feet 279 that may be used to level the storage compartment modules 203, 205, 207, 209 and/or control station 201 when located on un-level surfaces. In addition, the self-leveling feet 279 may also be adjusted so that a storage compartment module, such as storage compartment module 205, 207, can be positioned so it is flush and aligned with a control station 201 or another storage compartment module. As an alternative to self-leveling feet 279, any other type of support mechanism may be utilized with various implementations described herein for supporting the control station 201 or any storage compartment module 203, 205, 207, 209. Also, the control station 201 and one or more of the storage compartment modules 203, 205, 207, 209 may utilize different types of support mechanisms. For example, the control station 201 may utilize self-leveling feet while the storage compartment modules 203, 205, 207, 209 may utilize rolling casters or wheels. The casters/wheels may further enable the ease with which storage compartment modules may be added or removed from a control station 201, thereby allowing the easy addition/removal of capacity at the pickup location 200.

FIG. 3 depicts a block diagram of an illustrative distributed pickup location environment 301 that includes a group of distributed pickup locations 200(A), 200(B), 200(C), 200(D), 200(E), in one implementation. A group of corresponding geographic ranges 300(A), 300(B), 300(C), 300(D), 300(E) are served by each pickup location 200(A)-200(E). When an order for one or more items is placed by user, a shipment set may be assigned to a materials handling facility for fulfillment and delivery to the user. By strategically placing pickup locations 200, a user may select a pickup location, such as pickup location 200(A) that is in a geographically convenient location 300(A) as the delivery destination, rather than having the order delivered to their house, apartment, office or other location. This may be convenient to the user if they may not be available when the item would otherwise be delivered to the location, may not want others located at alternative delivery locations to know that they have ordered an item (e.g., a mother may not want a gift for their child delivered to the house) or may not want the item left at an unsecure location (e.g., front port, mailroom) if they are not present when the item is delivered.

When a user places an order for one or more items, an order planning system may determine if there is a pickup location, such as pickup location 200(A), within a geographic range 300(A) of where the user may wish to have the items delivered. In some instances, a user may designate or preselect preferred pickup locations 200, such as pickup location 200(A), 200(B). For example, a user may designate one pickup location 200(A) as a preferred pickup location near the user's home and a second pickup location 200(B) as a pickup location near the user's work. If an identified pickup location is available, the order planning system may determine if there is available capacity to receive the user's order prior to allowing the user to select the pickup location for delivery of an order. For items that have been ordered with a pickup location 200 designated as the delivery location, the materials handling facility 301 may prepare and ship the orders to each of those pickup locations, in some instances without requiring packaging for those orders. For example, orders assigned to pickup location 200(A) may be picked directly into one or more delivery containers, transported to the pickup location 200(A), placed in storage compartments of the pickup location 200(A) and made available for retrieval by the users.

In various implementations, the pickup locations 200(A), 200(B), 200(C), 200(D), 200(E) may communicate with one or more remote computing resources 310. The remote computing resources 310 may form a portion of a network-accessible computing platform implemented as a computing infrastructure of processors, storage, software, data access, and other components that is maintained and accessible via a network 308. The pickup locations 200(A), 200(B), 200(C), 200(D), 200(E) may communicatively couple to the remote computing resources 310 via the network 308 which may represent wired technologies (e.g., wires, USB, fiber optic cable, etc.), wireless technologies (e.g., RF, cellular, satellite, Bluetooth, etc.), and/or other connection technologies. The network 308 carries data between the pickup locations and the remote computing resources 310. For example, the communications to and from the pickup locations may utilize the main access point 232 and/or the wireless antennas of the pickup locations, such as the wireless antennas 241, 243, 231, 245, 247 described above with respect to FIG. 2. Communications may be to and from the command component of the control station for each of the pickup locations, such as the control station 201, and may also be to and from the storage compartment management components of each connected storage compartment module, such as the storage compartment modules 203, 205, 207, 209.

As illustrated, the remote computing resources 310 may include one or more servers, such as servers 320(1), 320(2), . . . , 320(N). These servers 320(1)-(N) may be arranged in any number of ways, such as server farms, stacks, and the like that are commonly used in data centers. Furthermore, the servers 320(1)-(N) may include one or more processors 322 and memory 324 which may store a storage compartment control system 326.

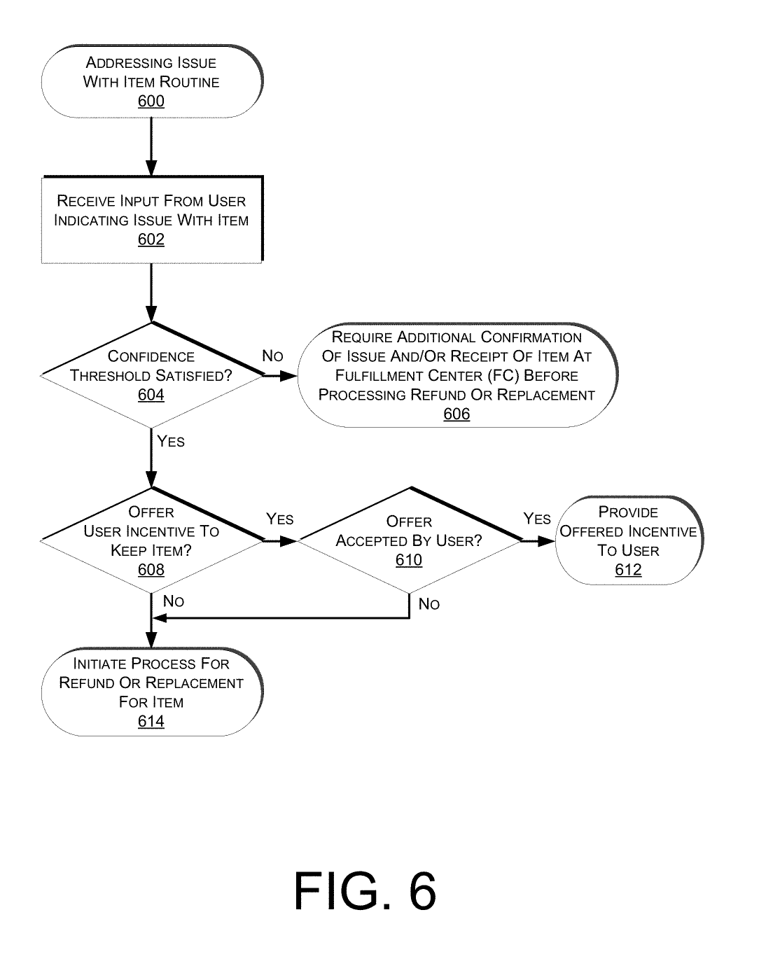

The storage compartment control system 326 may be configured, for example, to communicate with the pickup locations 200(A), 200(B), 200(C), 200(D), 200(E). In various implementations, the general activities of the pickup locations may require communications with the storage compartment control system 326. Certain types of feedback from a user may be received and processed either at a control station 201 of a respective pickup location 200(A) or at a remote computing resource 310. For example, as will be described in more detail below with respect to FIG. 6, an input from a user indicating an issue with an item may be received at either a control station 201 of a respective pickup location 200(A) or at a remote computing resource 310. In response to the input from the user, a determination may be made as to what action may be taken to address the issue. For example, in response to a missing or damaged item, a remote computing resource 310 may issue a refund to the user's account or place an order for a replacement item, or the control station 201 may be configured to directly dispense cash or other type of monetary credit to the user.

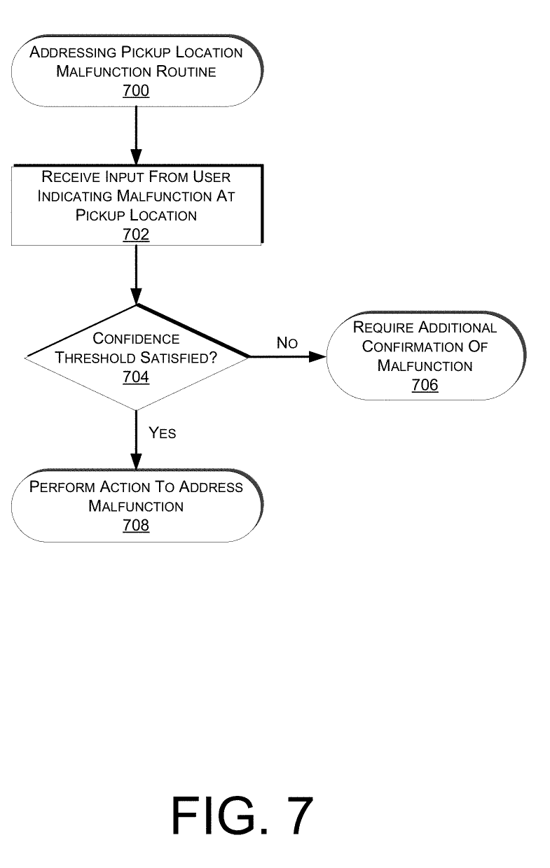

As another example, as will be described in more detail below with respect to FIG. 7, an input from a user indicating a malfunction at a pickup location may also be received and processed either at the control station 201 of the respective pickup location 200(A) or at a remote computing resource 310. For certain types of malfunctions, such as those related to a storage compartment at the pickup location, the user may be able to provide the input at the control station 201 of the pickup location while the user is experiencing the malfunction. Alternatively, the input may be provided to a remote computing resource 310, such as through a text or e-mail which may be more convenient for the user, or if the control station 201 itself is not operational for receiving input directly due to the malfunction.

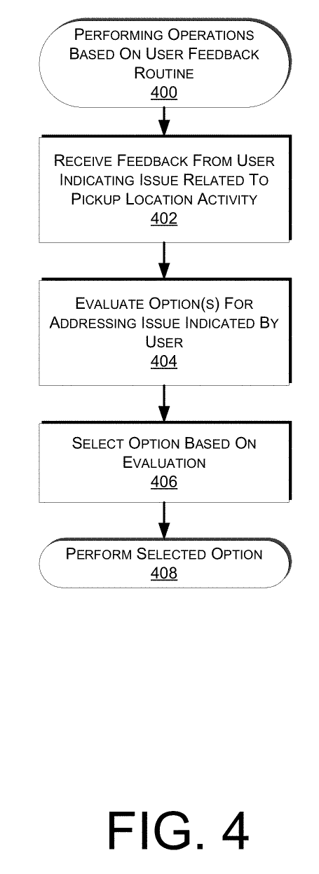

FIG. 4 is a flow diagram illustrating an example process 400 for performing pickup location operations based on user feedback. This process, and each process described herein, may be implemented by the architectures described herein or by other architectures. The process is illustrated as a collection of blocks in a logical flow graph. Some of the blocks represent operations that can be implemented in hardware, software, or a combination thereof In the context of software, the blocks represent computer-executable instructions stored on one or more computer readable media that, when executed by one or more processors, perform the recited operations. Generally, computer-executable instructions include routines, programs, objects, components, data structures, and the like that perform particular functions or implement particular abstract data types.

The computer readable media may include non-transitory computer readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations the computer readable media may include a transitory computer readable signal (in compressed or uncompressed form). Examples of computer readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation, and any number of the described operations can be combined in any order and/or in parallel to implement the process.

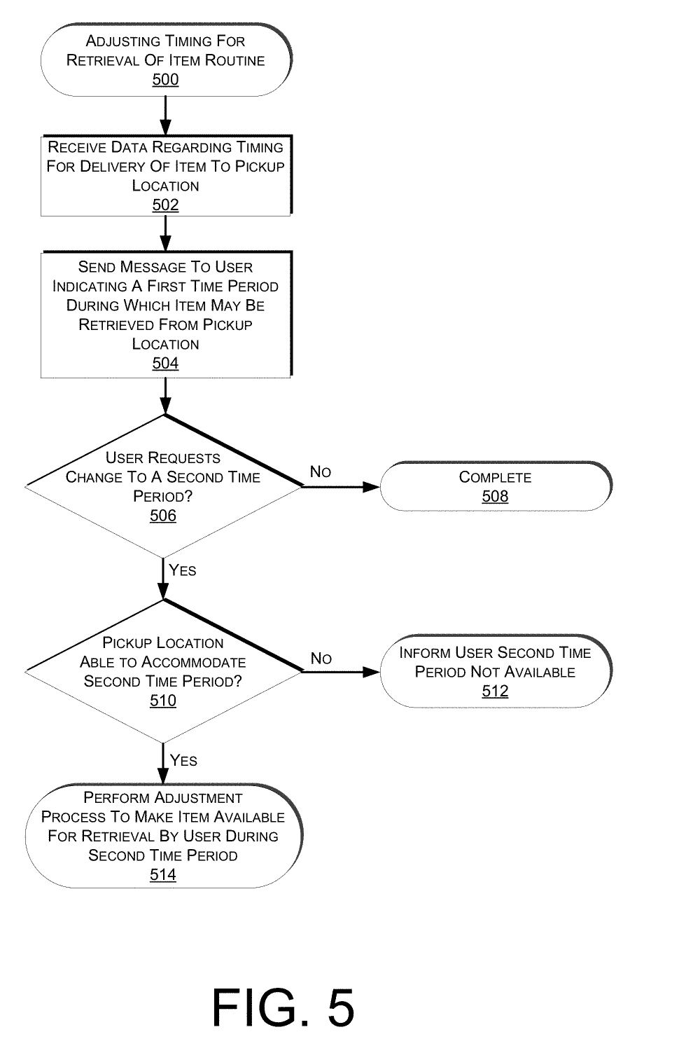

The example process 400 begins with the receipt of feedback from a user that indicates an issue related to a pickup location activity, as in 402. Examples of pickup location activities include a user retrieving an item that was ordered for the user and a user delivering an item for a return. The feedback from the user may indicate various types of issues related to the pickup location activity. For example, as will be described in more detail below with respect to FIG. 5, the issue that is indicated may be that a user will not be able to retrieve an item from the pickup location before the expiration of a time period that has been allotted for the user. As another example, as will be described in more detail below with respect to FIG. 6, the issue that is indicated may be that an item was missing or damaged during shipping or that the user otherwise wishes to return the item. As another example, as will be described in more detail below with respect to FIG. 7, the issue that is indicated may be that a malfunction is occurring at the pickup location, such as with a storage compartment or a control station. In various implementations, the feedback may be provided by the user in various ways. For example, the feedback may be input at a control station 201 of the pickup location 200 or may be received at a remote computing resource 310 and/or may be provided in the form of an email, phone call, text message, etc. In one implementation, a user may be sent an email or text message after the user retrieves an item which asks for feedback regarding the retrieval experience. In response, the user may send a reply email or text which includes feedback which indicates an issue related to the retrieval of the item.

Once the feedback from the user has been received, options for addressing the issue indicated by the user are evaluated, as in 404. For example, if the issue indicated by the user is that the user will not be able to retrieve an item during a scheduled time period, options for different time periods may be evaluated. As another example, if the issue indicated by the user is that an item was damaged during shipping, options for initiating a refund or replacement process for the item may be evaluated. As another example, if the issue indicated by the user is that a malfunction is occurring at the pickup location, options for addressing the malfunction may be evaluated. As will be described in more detail, as part of the evaluation, a determination may also be made as to whether a confidence threshold has been satisfied. In various implementations, the confidence threshold may represent a confidence in the occurrence of the issue that is indicated by the user. For example, the determination of whether the confidence threshold is satisfied may be based at least in part on an evaluation of the user's past purchases and returns of items and/or reports of issues. As another example, the determination of whether the confidence threshold has been satisfied may also or alternatively be based at least in part on the receipt of one or more additional reports or confirmations of the issue that is indicated by the user.

Once the options have been evaluated for addressing the issue indicated by the user, at least one of the options is selected based on the evaluation, as in 406. Once the option(s) is selected based on the evaluation, the selected option(s) is performed, as in 408. For example, in response to a malfunctioning lock on a storage compartment, an option for disabling the storage compartment may be selected and performed. In various implementations, the selection and performance of the option may be based at least in part on additional input from the user. For example, in response to a request from a user to change a time period that has been provided for the user to retrieve an item from the pickup location, the user may further be asked to select one of several available alternative time periods.

FIG. 5 is a flow diagram illustrating an example process 500 for adjusting the timing for the retrieval of an item from a pickup location by a user. The example process begins when data is received regarding the timing for a delivery of an item to a pickup location, as in 502. For example, when an item is shipped to the pickup location, a manufacturer or distributor which is shipping the item, or a carrier which is delivering the item, may provide a notification when the item is shipped and/or an estimated time of arrival at the pickup location. As another example, when the item is delivered to the pickup location, the data regarding the timing for the delivery may consist of a confirmation from the control station 201 or carrier that the item has been delivered to the pickup location. Alternatively, an estimated timing for the delivery may also be determined when the item is first ordered, although the accuracy for such an estimation may be greater once the item is actually shipped. An estimated timing that is determined when the item is first ordered may be made to conservatively include a maximum expected amount of time that it may take for the item to arrive at the pickup location, and may be utilized as the basis for a promise date. For example, when a user places an order for an item, a promise date may be indicated to the user which in one implementation may be intended to be the latest possible date by which the item will arrive. In such an instance, due to the nature of the promise date, the actual delivery date of the item to the pickup location may frequently be earlier than the promise date. As a result, the item may arrive at the pickup location earlier than the user had been expecting. If the user is given a limited time period to retrieve the item, such as three days, the arrival of the item before the user was expecting may result in the user not being able to retrieve the item before the time period expires. In response, the user may request a change to a second time period, as will be described in more detail below.

Once the data regarding the timing for the delivery of the item is received, a message is sent to the user indicating a first time period during which the item may be retrieved from the pickup location, as in 504. For example, the message to the user may indicate that the item has arrived or is expected to arrive at the pickup location on a certain date, and that the user will have a certain time period, such as three days, in which to retrieve the item, before the item will be returned to a fulfillment center. In one implementation, the message that is sent to the user may also include options for alternative time periods that may be selected by the user. For example, the message may be in the form of an email that includes different selection buttons for choosing different time periods. In one implementation, a message may also be sent to the user which includes an offer with an incentive to switch to an alternative time period. For example, if the storage capacity of the pickup location has been overbooked, it may be desirable to offer a user an incentive such as free shipping or other compensation to voluntarily delay the delivery of an item so that another item may take the place of the item.

Once the message is sent to the user indicating the first time period, a determination is made as to whether the user has requested a change to a second time period, as in 506. In various implementations, the second time period may include an extension or shifting of the time window indicated by the first time period. For example, if the first time period includes a three day time window (e.g., a Tuesday through Thursday) when the user can retrieve the item, the second time period including an extension of one day may include a four day time window (e.g., a Tuesday through Friday) when the user can retrieve the item. As another example, the three day time window may be shifted forward by one day (e.g., a Wednesday through Friday). In various implementations, the request from the user to change the time period may be received in the form of a message from the user, such as a text or e-mail, or may be made through a user's account on a website.

If at decision block 506 it is determined that the user has not requested a change to a second time period, the example process completes, as in 508. If the user has requested a change to a second time period, a determination is made as to whether the pickup location is able to accommodate a second time period, as in 510. In various implementations, the storage capacity and current scheduled activities for the pickup location may be evaluated to determine if a second time period can be accommodated. For example, if the pickup location is already at its maximum scheduled capacity, the pickup location may not be able to accommodate a second time period. If at decision block 510 it is determined that the pickup location is not able to accommodate the second time period, the user is informed that a second time period is not available, as in 512. In some implementations, the user may be given the option to have the package moved to another nearby pickup location that does have capacity for accommodating the second time period, or for having the item shipped to a home or other delivery address for the user.

If at decision block 510 it is determined that the pickup location is able to accommodate a second time period, then an adjustment process is performed to make the item available for retrieval by the user during the second time period, as in 514. In various implementations, the adjustment process to make the item available for retrieval by the user during the second time period may include delaying the delivery of the item to a storage compartment at the pickup location. In such a case, another item may be allowed to take the place of the item in the storage compartment, so as to most efficiently utilize the available storage capacity of the pickup location. In various implementations, the delaying of the delivery of the item to the storage compartment may be accomplished by refusing delivery of the item by a carrier on a first attempt but then accepting delivery on a later attempt. For example, a carrier may have a policy of attempting redelivery of an item one or more times before it is returned to a fulfillment center. Alternatively, the pickup location may have a bulk storage area (e.g., a large general storage compartment), where the item may be held until it is ready to be delivered to the respective storage compartment from which it will be retrieved by the user.

FIG. 6 is a flow diagram illustrating an example process 600 for addressing an issue with an item. The example process begins with the receipt of an input from a user indicating an issue with an item, as in 602. For example, the user may have arrived at a pickup location to retrieve an item that was ordered for the user, and once the user opens the storage compartment the user may discover that the item is missing or damaged. Alternatively, the user may wish to return the item for other reasons, such as having ordered multiple versions of an item in order to select a preferred size or color. In various implementations, the input from the user that indicates the issue with the item may be received in various ways. For example, the input may be received at a control station 201 of the pickup location 200 or at a remote computing resource 310 and/or may be provided in the form of an email, phone call, text message, etc.

Once the input is received from the user indicating the issue with the item, a determination is made as to whether a confidence threshold is satisfied, as in 604. In various implementations, the determination of whether the confidence threshold has been satisfied may be based at least in part on an evaluation of the user's past purchases and returns of items and reports of issues. For example, problems with a user's past returns of items, such as the item not being in the condition indicated by the user or items not being returned when or how they were supposed to be, may result in the confidence threshold not being satisfied. In various implementations, the confidence threshold may be different for different users, pickup locations, issues, items, etc. For example, a high value item may have a higher confidence threshold to be met than a low value item. As another example, a fragile item (e.g., a mirror) may have a relatively low confidence threshold to be met with respect to a report that the item was broken during shipping.

If at decision block 604 it is determined that the confidence threshold has not been satisfied, then additional confirmation of the issue and/or a return of the item to a fulfillment center may be required before a refund or a replacement process is initiated for the item, as in 606. In one implementation, additional confirmation of the issue may be based at least in part on an evaluation of data received from a sensor in the storage compartment where the item is/was stored. For example, if the user has indicated that the item was missing or damaged during shipping, a presence detection sensor 271, motion sensor 272, image capture device 273 and/or temperature sensor 274 within the storage compartment may all provide data regarding the presence and condition of the item. In one implementation, an image from the image capture device 273 may be reviewed to determine the previous presence and/or condition of the item before the storage compartment was accessed by the user.

If at decision block 604 it is determined that the confidence threshold has been satisfied, then a determination is made as to whether the user will be provided with an offer that includes an incentive to keep the item, as in 608. For example, if an item is damaged during shipping, rather than incurring the cost of returning the item to a fulfillment center, a determination may be made to offer the user a discount to keep the item. The discount may be applied in the form of a refund of a certain percentage of the original purchase price of the item, which may be credited to the user's account, or dispensed as a credit or cash directly from the control station 201. If at decision block 608 it is determined that an offer will be made to the user including an incentive to keep the item, a determination is made as to whether the offer is accepted by the user, as in 610. If the offer is accepted by the user, the offered incentive is provided to the user, as in 612.

If at decision block 608 it is determined that the user will not be provided with an offer including an incentive to keep the item, or if at decision block 610 the user does not accept the offer, a refund or replacement process for the item is initiated, as in 614. In various implementations, the initiation of the refund or replacement process for the item may include crediting the user's account with a refund for the purchase price of the item, or placing an order for shipping a replacement item. In one implementation, if the pickup location already has a replacement item in another storage compartment, such as may occur for high volume items, the replacement item may be offered for immediate retrieval by the user.

FIG. 7 is a flow diagram illustrating an example process 700 for addressing a pickup location malfunction. The example process begins with the receipt of an input from a user that indicates a malfunction at a pickup location, as in 702. For example, the malfunction may be related to a storage compartment at the pickup location, such as a door that will not open for the retrieval of an item, or that will not stay closed or locked for the return of an item. A malfunction may also be related to certain functions of the control station 201, such as not receiving or processing input from the user correctly, or for providing certain services. The input from the user indicating the malfunction at the pickup location may be received through various sources. For example, for certain types of malfunctions, such as those related to a storage compartment at the pickup location, the user may be able to provide the input at the control station 201 of the pickup location. Alternatively, the input may be provided to a remote computing resource 310, such as through a text or email which may be more convenient for the user, or if the control station 201 itself is not operational for receiving such input directly due to the malfunction.

Once the input has been received from the user at the pickup location, a determination is made as to whether a confidence threshold has been satisfied, as in 704. In various implementations, the determination of whether the confidence threshold has been satisfied may be based at least on part on an evaluation of the user's past purchases and returns of items and/or past reports of malfunctions. For example, if a user has in the past incorrectly reported malfunctions, additional confirmations of the malfunction may be required. The determination of whether the confidence threshold has been satisfied may also or alternatively be based at least in part on the receipt of a sufficient number of additional reports or confirmations of the malfunction. For example, multiple reports of a malfunction of the control station 201 may be considered sufficient for disabling all or part of the control station 201. In various implementations, the confidence threshold may be different for different users, pickup locations, issues, etc. For example, a user who is a carrier reporting a malfunction may have a lower confidence threshold to be met than a user who is a first time buyer. As another example, a high volume pickup location may have a higher threshold for disabling equipment than a low volume pickup location. If at decision block 704 it is determined that the confidence threshold has not been satisfied, additional confirmation of the malfunction may be required, as in 706. In one implementation, additional confirmation of the malfunction may be provided by additional reports of the malfunction from other users of the pickup location, or through various diagnostic processes that may be performed as initiated by the control station or a remote computing resource.

If at decision block 704 it is determined that the confidence threshold has been satisfied, then action is performed to address the malfunction, as in 708. For example, if the malfunction is related to a storage compartment at the pickup location, the action may include disabling the storage compartment for future deliveries, rerouting existing items that are scheduled for delivery to the storage compartment to a different storage compartment or pickup location and/or sending a request for repair of the storage compartment. If the malfunction of the storage compartment has caused the door of the storage compartment to not be able to be opened, options may be provided to the user related to the inability to retrieve the item. For example, as previously described with respect to FIG. 6, a refund or replacement process may be initiated, or if an identical item is available in another storage compartment, such as may occur for high volume items, the user may be provided with an option for immediately retrieving the identical item. In some instances, the malfunction of the storage compartment may not be critical to its overall operation, such as one of the sensors 271, 272, 273 or 274 malfunctioning, in which case the sensor may be disabled and/or the storage compartment may be allowed to continue to operate on a limited basis until a repair process can be completed. For example, if the temperature sensor 274 is malfunctioning, the temperature sensor 274 may be disabled and/or the storage compartment may not be allowed to be utilized as a refrigerated storage compartment for storing refrigerated items. If the malfunction is related to one or more of the functions of the control station 201, the actions to address the malfunction may include sending a request for repair and/or disabling the related functions and/or the control station 201 as a whole. A message may also be provided on the user interface of the control station or otherwise to inform users that certain functions cannot be performed and/or that the control station 201 as a whole is out of order.

FIG. 8 is a block diagram illustrating an example computer system 800 configured to implement one or more of the systems or processes described herein. In various examples, the block diagram may be illustrative of one or more aspects of the control station 201 (FIG. 2) and/or the remote computing resource(s) 310 (FIG. 3) discussed above. In the illustrated implementation, the computer system 800 includes one or more processors 810A, 810B through 810N, coupled to a non-transitory computer readable storage medium 820 via an input/output (I/O) interface 830. The computer system 800 further includes a network interface 840 coupled to an I/O interface 830, and one or more input/output devices 850. In some implementations, it is contemplated that components of a storage compartment control system and/or a pickup location (e.g., user interface, command component, storage compartment management component, control station) may be implemented using a single instance of the computer system 800, while in other implementations, multiple such systems or multiple nodes making up the computer system 800 may be configured to host different portions, components or instances of a storage compartment control system and/or pickup location. For example, in one implementation, some data sources or services (e.g., capturing images or video within a storage compartment, computing available space within a storage compartment, detecting issues at the pickup location) may be implemented via one or more nodes of the computer system 800 that are distinct from those nodes implementing other data sources or services (e.g., providing commands to open a storage compartment, providing messaging to users, receiving input from users regarding issues at the pickup location). In some implementations, a given node may implement the functionality of more than one component of a storage compartment control system and/or a pickup location.

In various implementations, the computer system 800 may be a uniprocessor system including one processor 810A, or a multiprocessor system including several processors 810A-810N (e.g., two, four, eight, or another suitable number). The processors 810A-810N may be any suitable processor capable of executing instructions. For example, in various implementations the processors 810A-810N may be general-purpose or embedded processors implementing any of a variety of instruction set architectures (ISAs), such as the x86, PowerPC, SPARC, or MIPS ISAs, or any other suitable ISA. In multiprocessor systems, each of the processors 810A-810N may commonly, but not necessarily, implement the same ISA.

The non-transitory computer readable storage medium 820 may be configured to store executable instructions and/or data accessible by the one or more processors 810A-810N. In various implementations, the non-transitory computer readable storage medium 820 may be implemented using any suitable memory technology, such as static random access memory (SRAM), synchronous dynamic RAM (SDRAM), nonvolatile/Flash-type memory, or any other type of memory. In the illustrated implementation, program instructions and data implementing desired functions, such as those described above, are shown stored within the non-transitory computer readable storage medium 820 as program instructions 825 and data storage 835, respectively. In other implementations, program instructions and/or data may be received, sent or stored upon different types of computer-accessible media, such as non-transitory media, or on similar media separate from the non-transitory computer readable storage medium 820 or the computer system 800. Generally speaking, a non-transitory, computer readable storage medium may include storage media or memory media such as magnetic or optical media, e.g., disk or CD/DVD-ROM coupled to the computer system 800 via the I/O interface 830. Program instructions and data stored via a non-transitory computer readable medium may be transmitted by transmission media or signals such as electrical, electromagnetic, or digital signals, which may be conveyed via a communication medium such as a network and/or a wireless link, such as may be implemented via the network interface 840.

In one implementation, the I/O interface 830 may be configured to coordinate I/O traffic between the processors 810A-810N, the non-transitory computer readable storage medium 820, and any peripheral devices in the device, such as the computer systems of the storage compartment modules, the network interface 840 or other peripheral interfaces, such as input/output devices 850. In some implementations, the I/O interface 830 may perform any necessary protocol, timing or other data transformations to convert data signals from one component (e.g., non-transitory computer readable storage medium 820) into a format suitable for use by another component (e.g., processors 810A-810N). In some implementations, the I/O interface 830 may include support for devices attached through various types of peripheral buses, such as a variant of the Peripheral Component Interconnect (PCI) bus standard or the Universal Serial Bus (USB) standard, for example. In some implementations, the function of the I/O interface 830 may be split into two or more separate components, such as a north bridge and a south bridge, for example. Also, in some implementations, some or all of the functionality of the I/O interface 830, such as an interface to the non-transitory computer readable storage medium 820, may be incorporated directly into the processors 810A-810N.

The network interface 840 may be configured to allow data to be exchanged between the computer system 800 and other devices attached to a network, such as other computer systems, or between nodes of the computer system 800. For example, the network interface 840 may utilize the wireless antennas 241, 243, 231, 245, 247 to allow interaction and interface between the storage compartment control system 326 and the command component of the control station 201 and the storage compartment management component of each connected storage compartment module 203, 205, 207, 209. In various implementations, the network interface 840 may support communication via wired or wireless general data networks, such as any suitable type of Ethernet network. For example, the network interface 840 may support communication via telecommunications/telephony networks such as analog voice networks or digital fiber communications networks, via storage area networks such as Fibre Channel SANs, or via any other suitable type of network and/or protocol.

Input/output devices 850 may, in some implementations, include one or more display terminals, keyboards, keypads, touchpads, scanning devices, voice or optical recognition devices, or any other devices suitable for entering or retrieving data by one or more computer systems 800. Multiple input/output devices 850, such as a user interface for the storage compartment control system 326 and/or the user interface 211, may be present in the computer system 800 or may be distributed on various nodes of the computer system 800. In some implementations, similar input/output devices may be separate from the computer system 800 and may interact with one or more nodes of the computer system 800 through a wired or wireless connection, such as over the network interface 840. For example, the computer systems of the storage compartment modules 203, 205, 207, 209 and/or the locking mechanisms of those storage compartment modules may communicate with the computer system 800 as input/output devices 850 over wired or wireless network interface 840.

As shown in FIG. 8, the memory 820 may include program instructions 825 which may be configured to implement a storage compartment control system and/or pickup location data storage 835, which may comprise various tables, databases and/or other data structures accessible by the program instructions 825. In one implementation, the program instructions 825 may include various software modules configured to implement a user interface 211, security, locking and unlocking of storage compartments, management of the pickup location, and functions of the storage compartment control system 326, such as receiving input from users regarding issues at the pickup location and performing actions to address the issues. The data storage 835 may include various data stores for maintaining one or more storage compartment module configurations, data representing presence or absence of items contained in various storage compartments, access information for various storage compartments and/or other item parameter values. The data storage 835 may also include one or more data stores for maintaining data representing issues reported by users, item deliveries, retrievals, returns, hold orders, partial orders, transfer container locations, and other information utilized by the storage compartment control system and/or pickup location.

In various implementations, the parameter values and other data illustrated herein as being included in one or more data stores may be combined with other information not described or may be partitioned differently into more, fewer, or different data structures. In some implementations, data stores used in the storage compartment control system and/or in a pickup location and/or in components or portions thereof, may be physically located in one memory or may be distributed among two or more memories. These memories may be part of a single computer system or they may be distributed among two or more computer systems, such as two computer systems connected by a wired or wireless local area network, or through the Internet, in different implementations. Similarly, in other implementations, different software modules and data stores may make up a pickup location system and/or any of the various components thereof described herein.

Those skilled in the art will appreciate that the computing system 800 is merely illustrative and is not intended to limit the scope of the present disclosure. In particular, the computing system and devices may include any combination of hardware or software that can perform the indicated functions, including computers, network devices, internet appliances, PDAs, wireless phones, pagers, etc. The computing system 800 may also be connected to other devices that are not illustrated, or instead may operate as a stand-alone system. In addition, the functionality provided by the illustrated components may in some implementations be combined in fewer components or distributed in additional components. Similarly, in some implementations the functionality of some of the illustrated components may not be provided and/or other additional functionality may be available.

Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated computing system via inter-computer communication. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various implementations may further include receiving, sending or storing instructions and/or data implemented in accordance with the foregoing description upon a computer-accessible medium. Accordingly, the techniques described herein may be practiced with other computer system configurations.

Those skilled in the art will appreciate that in some implementations the functionality provided by the processes and systems discussed above may be provided in alternative ways, such as being split among more software modules or routines or consolidated into fewer modules or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a computer readable storage medium, other aspects may likewise be so embodied. Various modifications and changes may be made as would be obvious to a person skilled in the art having the benefit of this disclosure. It is intended to embrace all such modifications and changes and, accordingly, the above description to be regarded in an illustrative rather than a restrictive sense.

1.-20. (canceled)

21. A pickup location apparatus, comprising:
a storage compartment with a locking mechanism; and
a control station configured to control the locking mechanism, the control station comprising:
an input device configured to receive an input of an access code to provide access to the storage compartment; and
a computing system, comprising:
one or more processors; and
a memory coupled to the one or more processors and storing program instructions that when executed by the one or more processors cause the one or more processors to at least:
receive an input from a user which indicates an issue related to a pickup location activity, wherein the pickup location activity includes accessing the storage compartment of the pickup location apparatus and the issue includes that a malfunction is occurring in the pickup location apparatus that prevents the user from accessing the storage compartment;
determine that a confidence threshold is satisfied, wherein the confidence threshold represents a confidence in the occurrence of the malfunction in the pickup location apparatus that is indicated by the input from the user; and
in response to the determination that the confidence threshold is satisfied, perform an issue addressing action to address the malfunction in the pickup location apparatus that is indicated by the input from the user, the issue addressing action including at least one of disabling at least part of the storage compartment and disabling at least part of the control station of the pickup location apparatus.

22. The pickup location apparatus of claim 21, wherein the pickup location activity includes a retrieval of an item from the storage compartment by the user, and the issue addressing action further includes an initiation of either a refund or replacement process for the item.

23. The pickup location apparatus of claim 21, wherein the determination that the confidence threshold has been satisfied is based at least in part on an evaluation of past purchases or returns of items by the user.

24. (canceled)

25. The pickup location apparatus of claim 21, wherein the determination that the confidence threshold has been satisfied is based at least in part on a receipt of one or more additional reports of the malfunction.

26. The pickup location apparatus of claim 21, wherein at least one of different types of items, issues, or users are associated with different confidence thresholds.

27. The pickup location apparatus of claim 26, wherein a first item is associated with a first confidence threshold and a second item is associated with a second confidence threshold, the first confidence threshold being set lower than the second confidence threshold due to the first item having a lower value than the second item.

28. A computer implemented method to address an issue related to a pickup location activity, the method comprising:
receiving an input from a user which indicates an issue related to a pickup location activity at a pickup location apparatus, the pickup location apparatus comprising a storage compartment with a locking mechanism and a control station configured to control the locking mechanism, wherein the pickup location activity includes accessing the storage compartment of the pickup location apparatus and the issue includes that a malfunction is occurring in the pickup location apparatus that prevents the user from accessing the storage compartment;
determining that a confidence threshold is satisfied, wherein the confidence threshold represents a confidence in the occurrence of the malfunction in the pickup location apparatus that is indicated by the input from the user; and
in response to the determination that the confidence threshold is satisfied, performing an issue addressing action to address the malfunction in the pickup location apparatus that is indicated by the input from the user.

29. (canceled)

30. The method of claim 28, wherein the determination that the confidence threshold has been satisfied is based at least in part on an evaluation of past purchases or returns of items by the user.

31. The method of claim 28, wherein the malfunction is occurring in at least one of the storage compartment or the control station of the pickup location apparatus.

32. The method of claim 28, wherein the determination that the confidence threshold has been satisfied is based at least in part on a receipt of one or more additional reports of the malfunction.

33. The method of claim 32, wherein at least one of the additional reports of the malfunction is provided by another user of the pickup location apparatus.

34. The method of claim 28, wherein the determination that the confidence threshold has been satisfied is based at least in part on a diagnostic process that is performed in response to the input from the user.

35. The method of claim 28, wherein at least one of different types of items, issues, users, or pickup location apparatuses are associated with different confidence thresholds.

36. The method of claim 35, wherein a first item is associated with a first confidence threshold and a second item is associated with a second confidence threshold, the first confidence threshold being set lower than the second confidence threshold due to the first item having a lower value than the second item.

37. (canceled)

38. The method of claim 28, wherein the pickup location activity includes a retrieval of an item from the storage compartment by the user, and the method further includes:
receiving an access code; and
sending a signal to control a locking mechanism to unlock a door of the storage compartment in response to the receipt of the access code, wherein as a result of the malfunction the door of the storage compartment is not able to be opened.

39.-42. (canceled)

43. The method of claim 38, wherein the issue addressing action that is performed includes providing the user with an option for immediately retrieving an identical item from another storage compartment of the pickup location apparatus.

44.-45. (canceled)

46. The method of claim 28, wherein the malfunction is related to the storage compartment of the pickup location apparatus and the issue addressing action that is performed includes disabling at least part of the storage compartment.

47. The method of claim 28, wherein the malfunction is related to the control station of the pickup location apparatus and the issue addressing action that is performed includes disabling one or more functions of the control station.

48. A system comprising:
a pickup location apparatus comprising:
a storage compartment with a locking mechanism; and
a control station configured to control the locking mechanism to unlock the storage compartment; and
a computing system, comprising:
one or more processors; and
a memory coupled to the one or more processors and storing program instructions that when executed by the one or more processors cause the one or more processors to at least:
receive an input from a user which indicates a malfunction of the pickup location apparatus as related to a pickup location activity at the pickup location apparatus, wherein the pickup location activity includes accessing the storage compartment of the pickup location apparatus and the malfunction affects an ability to access the storage compartment;
determine that a confidence threshold is satisfied, wherein the confidence threshold represents a confidence in an occurrence of the malfunction of the pickup location apparatus that is indicated by the input from the user; and
in response to the determination that the confidence threshold is satisfied, perform an issue addressing action to address the malfunction in the pickup location apparatus that is indicated by the input from the user.

49. The system of claim 48, wherein the malfunction is related to the control station of the pickup location apparatus and the issue addressing action that is performed includes disabling one or more functions of the control station.

50. The system of claim 48, wherein the malfunction is related to the storage compartment of the pickup location apparatus and the issue addressing action that is performed includes disabling at least part of the storage compartment.

51. The system of claim 48, wherein the issue addressing action that is performed includes:
disabling a malfunctioning component of the storage compartment; and
utilizing the storage compartment on a limited basis to store an item that is determined to not require use of the disabled component.

52. The system of claim 48, wherein the malfunction is related to the storage compartment of the pickup location apparatus and the issue addressing action that is performed includes rerouting an existing item that is scheduled for delivery to the storage compartment to a different storage compartment of the pickup location apparatus.

53. The system of claim 48, wherein the pickup location activity includes a retrieval of an item from the storage compartment by the user, and as a result of the malfunction the user is not able to access the storage compartment and the issue addressing action includes an initiation of either a refund or replacement process for the item.

54. The system of claim 48, wherein the pickup location activity includes a retrieval of an item from the storage compartment by the user, and as a result of the malfunction the user is not able to access the storage compartment and the issue addressing action includes providing the user with an option for immediately retrieving an identical item from another storage compartment of the pickup location apparatus.

55. The system of claim 48, wherein the determination that the confidence threshold has been satisfied is based at least in part on an evaluation of past purchases or returns of items by the user.

56. The system of claim 48, wherein the determination that the confidence threshold has been satisfied is based at least in part on a receipt of an input from another user that indicates the malfunction of the pickup location apparatus.
